(19) United States
(12) Patent Application Publication
(10) Pub. No.: US 2021/0039437 A1
(43) Pub. Date: Feb. 11, 2021

(54) Pneumatic Tire

(71) Applicant: The Yokohama Rubber Co., LTD., Minato-ku, Tokyo (JP)

(72) Inventor: Miyuki Oka, Hiratsuka-shi, Kanagawa (JP)

(21) Appl. No.: 16/967,715

(22) PCT Filed: Feb. 4, 2019
(86) PCT No.: PCT/JP2019/003912

§ 371 Date: Aug. 5, 2020

(30) Foreign Application Priority Data
Feb. 5, 2018 (JP) 2018-018278

(51) Int. Cl. B60C 1/00; C08L 7/00; C08F 136/06; C08K 3/04; C08K 3/36; C08L 91/00; B60C 11/03; C08L 9/06

(52) U.S. Cl. CPC B60C 1/0016; C08L 7/00; C08F 136/06; C08K 3/04; C08K 2201/006; C08L 91/00; B60C 11/03; C08L 9/06; B60C 2011/0341; C08K 3/36

(57) ABSTRACT

A pneumatic tire includes a main groove in a tread portion. The main groove has a groove depth of from 7 mm to 11 mm. A rubber composition for a tread constituting the tread portion includes a natural rubber, a styrene-butadiene rubber, and a butadiene rubber as a rubber component. The average glass transition temperature of the rubber component is −50° C. or lower. Silica is compounded in the rubber composition for a tread at 50 parts by mass to 100 parts by mass per 100 parts by mass of the rubber component. The compounded amount of the silica is 80 mass % or more of the total amount of carbon black and silica. Aroma oil is compounded in the rubber composition for a tread at 40 mass % or less relative to the amount of silica.

### TECHNICAL FIELD

The present technology relates to a pneumatic tire provided with a main groove extending in a tire circumferential direction in a surface of a tread portion.

### BACKGROUND ART

In recent years, various measures have been proposed for achieving improved wear resistance, lower fuel consumption (low rolling performance), improved steering stability performance on wet road surfaces (wet performance), and lower tire weight for rubber compositions that constitute pneumatic tires, and for achieving these aspects of performance in a compatible manner to a high degree (for example, see Japan Unexamined Patent Publication No. 2006-151244). It is known that, among these aspects of performance, wear resistance can generally be improved by compounding a large amount of carbon black in a rubber composition for a tread that constitutes the tread portion of the pneumatic tire. However, such a compounding proportion may adversely affect rolling characteristics. Thus, compounding silica in place of carbon black has also been proposed to improve rolling characteristics. However, there is a problem in that a high compounding ratio of silica may cause wear resistance and durability to decrease, and it is difficult to achieve the above-described aspects of performance in a compatible manner. As a result, there is a demand for measures for optimizing the compounding proportion of the rubber composition for a tread to improve wear resistance, low rolling performance, and steering stability on wet road surfaces while maintaining durability (scratch resistance while traveling on bad roads).

### SUMMARY

The present technology provides a pneumatic tire that can improve wear resistance, low rolling performance, and steering stability on wet road surfaces while maintaining durability (scratch resistance while traveling on bad roads).

A pneumatic tire according to an embodiment of the present technology includes a tread portion having an annular shape and extending in a tire circumferential direction, a pair of sidewall portions disposed on both sides of the tread portion, and a main groove extending in the tire circumferential direction in a surface of the tread portion, the main groove having a groove depth of from 7 mm to 11 mm, a rubber composition for a tread including, as a rubber component, a natural rubber, a styrene-butadiene rubber, and a butadiene rubber, the rubber composition for a tread constituting the tread portion, the rubber component having an average glass transition temperature Tg of −50° C. or lower, silica being compounded in the rubber composition for a tread at 50 parts by mass to 100 parts by mass per 100 parts by mass of the rubber component, a compounded amount of the silica being 80 mass % or more of a total amount of carbon black and the silica, and aroma oil being compounded in the rubber composition for a tread at 40 mass % or less relative to an amount of the silica.

With the pneumatic tire according to the embodiment of the present technology, because the rubber composition for a tread has the compounding proportion described above, it is possible to improve wear resistance, low rolling performance, and steering stability on wet road surfaces while maintaining durability (scratch resistance while traveling on bad roads). Particularly, because the rubber composition for a tread is employed in the tread portion where the groove depth of the main groove is within the range described above, the above-described performance can be effectively achieved.

In the present technology, the CTAB (cetyltrimethylammonium bromide) adsorption specific surface area of the silica is preferably from 140 m²/g to 220 m²/g. This configuration is advantageous for further improving the physical properties of the rubber composition for a tread and improving wear resistance, low rolling performance, and steering stability on wet road surfaces while maintaining durability.

In the present technology, the area ratio of the main groove to the ground contact area is preferably from 20% to 25%. By setting the area ratio of the main groove in this way, in cooperation with the rubber composition for a tread having the compounding proportion described above, the effects of improving wear resistance, low rolling performance, and steering stability on wet road surfaces while durability is maintained can be exhibited more effectively.

In the present technology, the strength at break TB (MPa), the elongation at break EB (%), and the storage modulus E′ (MPa) of the rubber composition for a tread preferably satisfy the relationship of 8≤(TB×EB)/(E′×100). As a result, the physical properties of the rubber composition for a tread become more balanced, which is advantageous for improving wear resistance, low rolling performance, and steering stability on wet road surfaces while maintaining durability. Note that the strength at break TB is a value (unit: MPa) measured at room temperature (23° C.) in conformance with JIS (Japanese Industrial Standard) K6251. The elongation at break EB is a value (unit: %) measured at room temperature (23° C.) in conformance with JIS K6251.

Additionally, the storage modulus E′ is a value (unit: MPa) measured at room temperature (23° C.) in accordance with JIS K6394 by using a viscoelasticity spectrometer under the following conditions: frequency=20 Hz, initial strain=10%, and dynamic distortion=±2%.

In the present technology, a “ground contact area” is the area of a contact region between end portions (contact ends) in the tire axial direction when the tire is mounted on a regular rim and inflated to a regular internal pressure, and placed vertically upon a flat surface with a regular load applied thereto. “Regular rim” is a rim defined by a standard for each tire according to a system of standards that includes standards on which tires are based, and refers to a “standard rim” in the case of JATMA (The Japan Automobile Tyre Manufacturers Association, Inc.), refers to a “design rim” in the case of TRA (The Tire and Rim Association, Inc.), and refers to a “measuring rim” in the case of ETRTO (The European Tyre and Rim Technical Organisation). In the system of standards, including standards with which tires comply, “regular internal pressure” is air pressure defined by each of the standards for each tire and is referred to as “maximum air pressure” in the case of JATMA, the maximum value being listed in the table “TIRE ROAD LIMITS AT VARIOUS COLD INFLATION PRESSURES” in the case of TRA, and is “INFLATION PRESSURE” in the case of ETRTO. However, “regular internal pressure” is 180 kPa in a case where a tire is for a passenger vehicle. “Regular load” is a load defined by a standard for each tire according to a system of standards that includes standards on which tires are based, and refers to a “maximum load capacity” in the case of JATMA, refers to the maximum value in the table of “TIRE ROAD LIMITS AT VARIOUS COLD INFLATION PRESSURES” in the case of TRA, and refers to “LOAD CAPACITY” in the case of ETRTO. “Regular load” corresponds to 88% of the loads described above for a tire on a passenger vehicle.

### BRIEF DESCRIPTION OF DRAWINGS

FIG. 1 is a meridian cross-sectional view of a pneumatic tire according to an embodiment of the present technology.

FIG. 2 is a plan view schematically illustrating an example of a tread portion of a pneumatic tire according to an embodiment of the present technology.

### DETAILED DESCRIPTION

Configurations of embodiments of the present technology will be described in detail below with reference to the accompanying drawings.

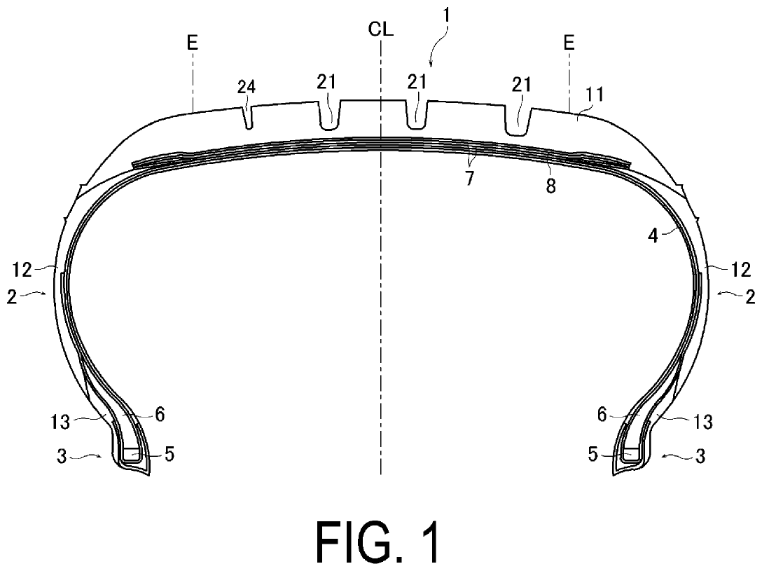

As illustrated in FIG. 1, the pneumatic tire of an embodiment of the present technology includes an annular tread portion 1 extending in the tire circumferential direction, a pair of sidewall portions 2 disposed on both sides of the tread portion 1, and a pair of bead portions 3 disposed on an inner side of the sidewall portions 2 in the tire radial direction. Note that, in FIG. 1, reference sign “CL” denotes a tire equator, and reference sign “E” denotes a ground contact edge.

A carcass layer 4 is mounted between the left-right pair of bead portions 3. The carcass layer 4 includes a plurality of reinforcing cords extending in the tire radial direction, and is folded back around a bead core 5 disposed in each of the bead portions 3 from a vehicle inner side to a vehicle outer side. Additionally, bead fillers 6 are disposed on the periphery of the bead cores 5, and each bead filler 6 is enveloped by a main body portion and a folded back portion of the carcass layer 4. On the other hand, in the tread portion 1, a plurality of belt layers 7 (two layers in FIG. 1) are embedded on an outer circumferential side of the carcass layer 4. The belt layers 7 each include a plurality of reinforcing cords that are inclined with respect to the tire circumferential direction, with the reinforcing cords of the different layers arranged in a criss-cross manner. In these belt layers 7, the inclination angle of the reinforcing cords with respect to the tire circumferential direction ranges from, for example, 10° to 40°. In addition, a belt reinforcing layer 8 is provided on the outer circumferential side of the belt layers 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

A tread rubber layer 11 is disposed on the outer circumferential side of the carcass layer 4 in the tread portion 1. A side rubber layer 12 is disposed on the outer circumferential side (outer side in the tire width direction) of the carcass layer 4 in each of the sidewall portions 2. A rim cushion rubber layer 13 is disposed on the outer circumferential side (outer side in the tire width direction) of the carcass layer 4 in each of the bead portions 3. The tread rubber layer 11 may have a structure in which two types of rubber layers (a cap tread rubber layer and an undertread rubber layer) with differing physical properties are layered in the tire radial direction.

The embodiment of the present technology is applied to a general pneumatic tire such as that described above. However, the basic structure thereof is not limited to the structure described above.

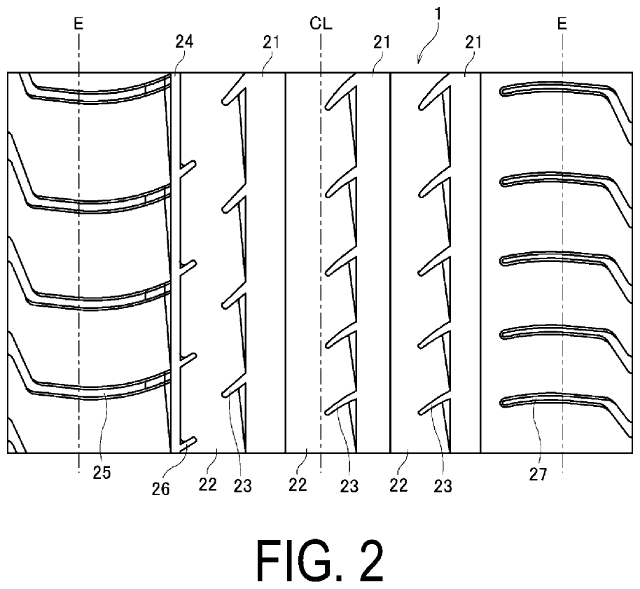

A plurality of main grooves 21 extending in the tire circumferential direction are always formed in the outer surface of the tread portion 1 of the pneumatic tire according to an embodiment of the present technology. Note that in the present technology, “main groove” refers to a groove having a groove width of from 10 mm to 20 mm extending in the tire circumferential direction, and does not include a narrow groove having a groove width of less than 10 mm (e.g., the circumferential narrow groove 24 in FIG. 2) despite extending in the tire circumferential direction. The groove depth of each main groove 21 is set to from 7 mm to 11 mm, preferably from 8 mm to 10 mm. Additionally, the groove width of the main groove 21 and the number of main grooves 21 are set such that the area ratio of the main groove 21 to the ground contact area is from 20% to 25%, preferably from 23% to 25%. For example, in the example illustrated in FIG. 2, three main grooves 21 are provided, and the groove width of each main groove 21 is set to, for example, from 6 mm to 10 mm. By setting the groove depth and the area ratio of the main groove 21 to a suitable range in this way, it is possible to provide wear resistance performance and wet performance in a well-balanced manner. In addition, because the main groove 21 is one factor of pass-by noise, setting the groove depth and area ratio as described above can reduce pass-by noise. When the groove depth of the main groove 21 is less than 7 mm, wet performance decreases. When the groove depth of the main groove 21 is greater than 11 mm, wear resistance performance decreases. When the groove area ratio of the main groove 21 is less than 20%, wet performance decreases. When the groove area ratio of the main groove 21 is greater than 25%, wear resistance performance decreases.

In the present technology, the structure of grooves other than the main grooves 21 is not particularly limited. For example, lug grooves and sipes extending in the tire width direction, and narrow grooves and sipes extending in the tire circumferential direction can be formed in land portions defined by the main grooves 21. The grooves other than the main grooves 21 can be formed as appropriate depending on desired tire performance. For example, in the example of FIG. 2, four rows of land portions 22 are defined by three main grooves 21. On one side of each main groove 21 in the tire width direction, a plurality of lug grooves 23 extending in the tire width direction and having one end communicating with the main groove 21 and another end terminating at the land portion 22 are provided at intervals in the tire circumferential direction. Additionally, a circumferential narrow groove 24 extending in the tire circumferential direction, a plurality of shoulder lug grooves 25 extending in the tire width direction on the outer side of the circumferential narrow groove 24 in the tire width direction, and lug grooves 26 that communicate with the circumferential narrow groove 24 and extend in the tire width direction toward the tire equator CL and terminate within the land portion 22 are provided on a shoulder land portion (land portion on the outermost side in the tire width direction) on one side in the tire width direction. Shoulder lug grooves 27 that extend beyond a ground contact edge E in the tire width direction without communicating with the main grooves 21 are formed in a shoulder land portion on the other side in the tire width direction. The tread pattern of FIG. 2 demonstrates superior tire performance when combined with an embodiment of the present technology.

In the rubber composition constituting the tread rubber layer 11 of an embodiment of the present technology (hereinafter referred to as “rubber composition for a tread”), the rubber component is a diene rubber. Specifically, the rubber component is constituted by three types of rubber, that is, a natural rubber, a styrene-butadiene rubber, and a butadiene rubber. By using three types of rubber, that is, natural rubber, styrene-butadiene rubber, and butadiene rubber as the diene rubber, it is possible to improve the wear resistance of the rubber composition. Any natural rubber or butadiene rubber that is regularly used in rubber compositions for a tread in a pneumatic tire may be used. As the styrene-butadiene rubber, an emulsion-polymerized styrene-butadiene rubber or a solution-polymerized styrene-butadiene rubber can be used, and these may be used singularly, or a plurality of these rubbers may be blended.

When using these three types of rubbers, the average glass transition temperature of the rubbers is set to −50° C. or lower, and preferably from −55° C. to −65° C. By setting the glass transition temperature in this way, good wear resistance can be obtained. When the average glass transition temperature of these rubbers exceeds −50° C., rolling resistance is adversely affected. Note that the average glass transition temperature is a weighted average value based on the glass transition temperature of each rubber and the compounded amount of each rubber.

The compounded amount of natural rubber is preferably from 5 to 20 wt. %, more preferably from 10 to 15 wt. % relative to 100 wt. % of the diene rubber. The compounded amount of styrene-butadiene rubber is preferably from 30 to 60 wt. %, more preferably from 40 to 50 wt. % relative to 100 wt. % of the diene rubber. The compounded amount of butadiene rubber is preferably from 20 to 40 wt. %, more preferably from 25 to 35 wt. % relative to 100 wt. % of the diene rubber.

Silica is always compounded in the rubber composition for a tread according to an embodiment of the present technology. By compounding silica, the strength of the rubber composition for a tread can be increased. The compounded amount of silica is from 50 parts by mass to 100 parts by mass, preferably from 60 parts by mass to 80 parts by mass, per 100 parts by mass of the diene rubber. When the compounded amount of silica is less than 50 parts by mass, wear resistance performance is adversely affected. When the compounded amount of silica exceeds 100 parts by mass, low rolling resistance is adversely affected.

The CTAB adsorption specific surface area of silica is not particularly limited but is preferably from 140 m²/g to 220 m²/g, and more preferably from 150 m²/g to 170 m²/g. When the CTAB adsorption specific surface area of silica is less than 140 m²/g, durability, wear resistance, and wet performance are adversely affected. When the CTAB adsorption specific surface area of silica exceeds 220 m²/g, workability is adversely affected.

The silica that is used may be a silica that is ordinarily used in rubber compositions for tires such as, for example, wet silica, dry silica, surface-treated silica, or the like. The silica may be appropriately selected from commercially available products. Silica obtained by a normal manufacturing methods can also be used.

The rubber composition for a tread according to an embodiment of the present technology may also include carbon black. By compounding carbon black, the strength of the rubber composition can be increased, thereby increasing wear resistance. A carbon black having, for example, an ISAF grade as a grade classified by ASTM D1765 is preferably used as the carbon black.

The compounded amount of carbon black is preferably from 3 to 30 parts by mass, more preferably from 5 to 20 parts by mass, per 100 parts by mass of the diene rubber.

When compounding carbon black, the compounded amount of silica is not less than 80 mass %, preferably not less than 85 mass %, of the total amount of carbon black and silica. By setting the proportion of silica in the filler sufficiently large as described above, rolling characteristics and durability can be improved. If the proportion of silica is less than 80 mass %, rolling characteristics will be adversely affected. Note that only silica may be compounded as the filler (the proportion of silica may be set to 100 mass %).

In the rubber composition for a tread according to an embodiment of the present technology, a silane coupling agent may be compounded with the silica in order to improve the dispersibility of the silica and improve reinforcing properties with the diene rubber. The compounded amount of the silane coupling agent is preferably from 5 to 15 mass %, and more preferably from 7 to 12 mass %, relative to the compounded amount of silica. When the compounded amount of the silane coupling agent is less than 5 wt. % of the compounded amount of silica, the effect of improving dispersibility of the silica cannot be sufficiently obtained. Additionally, when the compounded amount of the silane coupling agent exceeds 15 wt. %, the silane coupling agents will polymerize, and the desired effects cannot be obtained.

In the rubber composition for a tread according to an embodiment of the present technology, aroma oil is compounded in an amount of 40 mass % or less, preferably from 20 to 35 mass %, relative to the amount of silica described above. By compounding an appropriate amount of aroma oil in this manner, durability can be improved. If the compounded amount of the aroma oil exceeds 40 mass %, durability is adversely affected.

In the rubber composition for a tread according to an embodiment of the present technology, compounding agents other than those above may also be added. Examples of other compounding agents include various compounding agents generally used in rubber compositions for a pneumatic tire, such as fillers other than silica, vulcanization accelerators, anti-aging agents, liquid polymers, and thermoplastic resins. These compounding agents can be compounded in typical amounts conventionally used so long as the present technology is not hindered. As a kneader, a typical kneader for a rubber, such as a Banbury mixer, a kneader, or a roller may be used.

In the rubber composition for a tread according to an embodiment of the present technology configured with the above compounding proportion, the strength at break TB (MPa), the elongation at break EB (%), and the storage modulus E′ (MPa) preferably satisfy the relationship of 8≤(TB×EB)/ (E′×100), and more preferably satisfy the relationship of 8≤(TB×EB)/ (E′×100)≤18. By having such physical properties, durability against scratches can be effectively increased. When the strength at break TB (MPa), the elongation at break EB (%), and the storage modulus E′ (MPa) do not satisfy the relationship described above and satisfy the relationship of 8>(TB×EB)/(E′×100), the effect of increasing scratch resistance is limited. Note that the values of the strength at break TB (MPa), the elongation at break EB (%), and the storage modulus E′ (MPa) are not particularly limited, but the strength at break TB (MPa) can be set, for example, from 18 MPa to 24 MPa, the elongation at break EB (%) can be set, for example, from 400% to 600%, and the storage modulus E′ (MPa) can be set from 6.0 MPa to 12.0 MPa.

With the rubber composition for a tread according to an embodiment of the present technology, it is possible to improve wear resistance, low rolling performance, and steering stability on wet road surfaces while maintaining durability (scratch resistance while traveling on bad roads). Therefore, by adopting the tread portion 1 in which the groove depth and the area ratio of the main grooves 21 are set within the ranges described above, the performance described above can be more effectively achieved, and achieved in a well-balanced manner to a high degree.

The present technology is further explained below by examples. However, the scope of the present technology is not limited to these examples.

### EXAMPLES

Compounding ingredients other than vulcanization accelerators and sulfur were weighed for each of 23 types of rubber compositions for a tread shown in Tables 1 to 3 (Standard Example 1, Comparative Examples 1 to 7, and Examples 1 to 15). These compounding ingredients were kneaded in a 1.7 L sealed Banbury mixer for 5 minutes. Then, a master batch was discharged at a temperature of 150° C. and cooled at room temperature. The master batch was then added to the same 1.7 L sealed Banbury mixer and the vulcanization accelerators and sulfur were added. Then, the master batch was mixed for 2 minutes to produce the rubber compositions for a tread.

Note that in Tables 1 to 3, the compounded amounts of SBR (styrene butadiene rubber) 1 to 3 describe the compounded amounts of the net rubber component excluding the oil content of an oil extended product. In addition, the “Aroma oil” column describes a total amount including aroma oil compounded in the rubber composition for a tread and extender oil in the SBR.

Tables 1 to 3 also describe the values in the formula (TB×EB)/(E′×100) calculated based on the strength at break TB (MPa), the elongation at break EB (%), and the elastic modulus E′ (MPa) of the rubber compositions for each rubber composition for a tread.

Further, pneumatic tires were produced with the rubber composition for each tread used for the tread portion. Each pneumatic tire had a tire size of 235/65R16 and the basic structure illustrated in FIG. 1, and the groove depth of the main grooves and the groove area ratio of the main grooves were set as shown in Tables 1 to 3. The wear resistance performance, low rolling performance, steering stability performance on wet road surfaces (wet performance), and scratch resistance performance (durability) when driving on bad roads were evaluated according to the methods described below.

### Wear Resistance Performance

Each test tire was mounted on a wheel having a rim size of 16×7 J, inflated to an air pressure of 350 kPa, and mounted on a test vehicle. The amount of wear was measured after traveling a distance of 10000 km on a paved road. The evaluation results are expressed as index values using the reciprocal of the measurement values, with the Standard Example 1 being assigned the index of 100. A larger index value indicates a smaller amount of wear and excellent wear resistance performance.

### Low Rolling Performance

Each test tire was mounted on a wheel having a rim size of 16×7 J and inflated to an air pressure of 350 kPa. Using an indoor drum testing machine (drum diameter: 1707 mm), rolling resistance was measured when the tire was driven at a speed of 80 km/h while pushed against the drum under a load equivalent to 85% of the maximum load at the air pressure described in the 2009 JATMA Year Book. The evaluation results are expressed as index values using the reciprocal of the measurement values, with the Standard Example 1 being assigned the index of 100. A larger index value indicates lower rolling resistance and excellent low rolling performance.

### Wet Performance

Each test tire was mounted on a wheel having a rim size of 16×7 J, inflated to an air pressure of 350 kPa, and mounted on a test vehicle. Each test tire was subjected to a sensory evaluation for steering stability performance by test drivers on a wet road surface. The results were scored using a 5-point method with Standard Example 1 as a reference (3). A larger index value indicates superior wet performance (steering stability on wet road surfaces).

### Durability

Each test tire was mounted on a wheel having a rim size of 16×7 J, inflated to an air pressure of 350 kPa, and mounted on a test vehicle. The number of scratches were measured by visual observation of the tire after traveling a distance of 1000 km on an unpaved road. The evaluation results are expressed in the following five degrees. A score of “4” indicates that excellent durability comparable to a conventional tire was maintained, and a score of “5” indicates that particularly excellent durability was achieved.

1: More than 20 scratches, 2: 11 to 20 scratches, 3: 6 to 10 scratches, 4: 2 to 5 scratches, 5: 0 to 1 scratches

TABLE 1-1

| | | | Compar- | Compar- |
|---|---|---|---|---|
| | | Standard | ative | ative |
| | | Example 1 | Example 1 | Example 2 |
| NR | Parts by mass | | 30 | |
| SBR-1 | Parts by mass | | 70 | 70 |
| SBR-2 | Parts by mass | 100 | | |
| BR | Parts by mass | | | 30 |
| Silica 1 | Parts by mass | 30 | 70 | 70 |
| Silica 2 | Parts by mass | | | |
| Silica 3 | Parts by mass | | | |
| CB | Parts by mass | 45 | 10 | 10 |
| Silane coupling | Parts by mass | 2.4 | 5.6 | 5.6 |
| agent | | | | |
| Aroma oil | Parts by mass | 25 | 25 | 25 |
| Zinc oxide | Parts by mass | 3 | 3 | 3 |
| Sulfur | Parts by mass | 1.5 | 1.5 | 1.5 |
| Vulcanization | Parts by mass | 2 | 2 | 2 |
| accelerator | | | | |
| Silica ratio | Mass % | 40 | 88 | 88 |
| Oil ratio | Mass % | 83 | 36 | 36 |
| (TB × EB)/(E′ × 100) | | 7 | 10 | 8 |
| Groove depth of | mm | 7 | 7 | 7 |
| main groove | | | | |
| Main groove | % | 30 | 30 | 30 |
| area ratio | | | | |
| Wear resistance | Index value | 100 | 97 | 103 |
| performance | | | | |
| Low rolling | Index value | 100 | 101 | 103 |
| performance | | | | |
| Wet performance | Index value | 3 | 2.5 | 2.5 |
| Durability | Index value | 5 | 4 | 3 |

TABLE 1-2

| | | Exam- | Exam- | Exam- | Compar- |
|---|---|---|---|---|---|
| | | ple | ple | ple | ative |
| | | 1 | 2 | 3 | Example 3 |
| NR | Parts by mass | 20 | 20 | 20 | 20 |
| SBR-1 | Parts by mass | 50 | 50 | 50 | 50 |
| SBR-2 | Parts by mass | | | | |
| BR | Parts by mass | 30 | 30 | 30 | 30 |
| Silica 1 | Parts by mass | 70 | 70 | 70 | 70 |
| Silica 2 | Parts by mass | | | | |
| Silica 3 | Parts by mass | | | | |
| CB | Parts by mass | 10 | 10 | 10 | 10 |
| Silane | Parts by mass | 5.6 | 5.6 | 5.6 | 5.6 |
| coupling | | | | | |
| agent | | | | | |
| Aroma oil | Parts by mass | 10 | 20 | 28 | 35 |
| Zinc oxide | Parts by mass | 3 | 3 | 3 | 3 |
| Sulfur | Parts by mass | 1.5 | 1.5 | 1.5 | 1.5 |
| Vulcani- | Parts by mass | 2 | 2 | 2 | 2 |
| zation | | | | | |
| accelerator | | | | | |
| Silica ratio | Mass % | 88 | 88 | 88 | 88 |
| Oil ratio | Mass % | 14 | 29 | 40 | 50 |
| (TB × EB)/(E′ × 100) | | 10 | 10 | 11 | 13 |
| Groove | mm | 8 | 8 | 8 | 8 |
| depth | | | | | |
| of main | | | | | |
| groove | | | | | |
| Main groove | % | 30 | 23 | 23 | 30 |
| area ratio | | | | | |
| Wear | Index value | 104 | 102 | 101 | 99 |
| resistance | | | | | |
| performance | | | | | |
| Low rolling | Index value | 103 | 103 | 103 | 103 |
| performance | | | | | |
| Wet | Index value | 3.5 | 3.5 | 3.5 | 3 |
| performance | | | | | |
| Durability | Index value | 5 | 5 | 5 | 3 |

TABLE 1-3

| | | Exam- | Exam- | Exam- |
|---|---|---|---|---|
| | | ple | ple | ple |
| | | 4 | 5 | 6 |
| NR | Parts by mass | 20 | 20 | 20 |
| SBR-1 | Parts by mass | | 50 | 50 |
| SBR-2 | Parts by mass | 50 | | |
| BR | Parts by mass | 30 | 30 | 30 |
| Silica 1 | Parts by mass | 70 | | |
| Silica 2 | Parts by mass | | 70 | |
| Silica 3 | Parts by mass | | | 70 |
| CB | Parts by mass | 10 | 10 | 10 |
| Silane coupling | Parts by mass | 5.6 | 5.6 | 5.6 |
| agent | | | | |
| Aroma oil | Parts by mass | 20 | 20 | 25 |
| Zinc oxide | Parts by mass | 3 | 3 | 3 |
| Sulfur | Parts by mass | 1.5 | 1.5 | 1.5 |
| Vulcanization | Parts by mass | 2 | 2 | 2 |
| accelerator | | | | |
| Silica ratio | Mass % | 88 | 88 | 88 |
| Oil ratio | Mass % | 29 | 29 | 36 |
| (TB × EB)/(E′ × 100) | | 10 | 12 | 7 |
| Groove depth of | mm | 8 | 8 | 6 |
| main groove | | | | |
| Main groove | % | 23 | 23 | 30 |
| area ratio | | | | |
| Wear resistance | Index value | 103 | 105 | 97 |
| performance | | | | |
| Low rolling | Index value | 102 | 103 | 105 |
| performance | | | | |
| Wet performance | Index value | 3 | 3.5 | 3 |
| Durability | Index value | 5 | 5 | 4 |

TABLE 2-1

| | | Comparative | | | Comparative |
|---|---|---|---|---|---|
| | | Example 4 | Example 7 | Example 8 | Example 5 |
| NR | Parts by mass | 20 | 20 | 20 | 20 |
| SBR-1 | Parts by mass | 50 | 50 | 50 | 50 |
| SBR-2 | Parts by mass | | | | |
| BR | Parts by mass | 30 | 30 | 30 | 30 |
| Silica 1 | Parts by mass | 30 | 50 | 100 | 110 |
| Silica 2 | Parts by mass | | | | |
| Silica 3 | Parts by mass | | | | |
| CB | Parts by mass | 10 | 10 | 10 | 10 |
| Silane coupling agent | Parts by mass | 2.4 | 4 | 8 | 8.8 |
| Aroma oil | Parts by mass | 20 | 20 | 20 | 20 |
| Zinc oxide | Parts by mass | 3 | 3 | 3 | 3 |
| Sulfur | Parts by mass | 1.5 | 1.5 | 1.5 | 1.5 |
| Vulcanization | Parts by mass | 2 | 2 | 2 | 2 |
| accelerator | | | | | |
| Silica proportion | Mass % | 75 | 83 | 91 | 92 |
| Oil ratio | Mass % | 29 | 29 | 29 | 29 |
| (TB x EB)/(E′ × 100) | | 7 | 8 | 8 | 8 |
| Groove depth of main | mm | 8 | 8 | 8 | 8 |
| groove | | | | | |
| Main groove | % | 23 | 23 | 23 | 23 |
| area ratio | | | | | |
| Wear resistance | Index value | 96 | 100 | 99 | 99 |
| performance | | | | | |
| Low rolling | Index value | 107 | 105 | 97 | 95 |
| performance | | | | | |
| Wet performance | Index value | 2.5 | 3 | 3.5 | 3.5 |
| Durability | Index value | 3 | 5 | 5 | 5 |

TABLE 2-2

| | | Comparative | | | Comparative |
|---|---|---|---|---|---|
| | | Example 6 | Example 9 | Example 10 | Example 7 |
| NR | Parts by mass | 20 | 20 | 20 | 20 |
| SBR-1 | Parts by mass | 50 | 50 | 50 | 50 |
| SBR-2 | Parts by mass | | | | |
| BR | Parts by mass | 30 | 30 | 30 | 30 |
| Silica 1 | Parts by mass | 70 | 70 | 70 | 70 |
| Silica 2 | Parts by mass | | | | |
| Silica 3 | Parts by mass | | | | |
| CB | Parts by mass | 10 | 10 | 10 | 10 |
| Silane coupling agent | Parts by mass | 5.6 | 5.6 | 5.6 | 5.6 |
| Aroma oil | Parts by mass | 20 | 20 | 20 | 25 |
| Zinc oxide | Parts by mass | 3 | 3 | 3 | 3 |
| Sulfur | Parts by mass | 1.5 | 1.5 | 1.5 | 1.5 |
| Vulcanization | Parts by mass | 2 | 2 | 2 | 2 |
| accelerator | | | | | |
| Silica proportion | Mass % | 88 | 88 | 88 | 88 |
| Oil ratio | Mass % | 29 | 29 | 29 | 36 |
| (TB × EB)/(E′ × 100) | 10 | 10 | 10 | 10 | |
| Groove depth of main | mm | 6 | 7 | 11 | 12 |
| groove | | | | | |
| Main groove area ratio | % | 23 | 23 | 23 | 30 |
| Wear resistance | Index value | 100 | 101 | 104 | 103 |
| performance | | | | | |
| Low rolling | Index value | 103 | 103 | 103 | 103 |
| performance | | | | | |
| Wet performance | Index value | 3 | 3 | 3.5 | 3 |
| Durability | Index value | 5 | 5 | 4 | 3 |

TABLE 3

| | | Example | Example | Example | Example | Example |
|---|---|---|---|---|---|---|
| | | 11 | 12 | 13 | 14 | 15 |
| NR | Parts by mass | 20 | 20 | 20 | 20 | 30 |
| SBR-1 | Parts by mass | 50 | 50 | 50 | 50 | 40 |
| SBR-2 | Parts by mass | | | | | |
| BR | Parts by mass | 30 | 30 | 30 | 30 | 30 |
| Silica 1 | Parts by mass | 70 | 70 | 70 | 70 | 70 |
| Silica 2 | Parts by mass | | | | | |
| Silica 3 | Parts by mass | | | | | |
| CB | Parts by mass | 10 | 10 | 10 | 10 | 10 |
| Silane coupling agent | Parts by mass | 5.6 | 5.6 | 5.6 | 5.6 | 5.6 |
| Aroma oil | Parts by mass | 20 | 20 | 20 | 20 | 20 |
| Zinc oxide | Parts by mass | 3 | 3 | 3 | 3 | 3 |
| Sulfur | Parts by mass | 1.5 | 1.5 | 1.5 | 1.5 | 1.2 |
| Vulcanization accelerator | Parts by mass | 2 | 2 | 2 | 2 | 2 |
| Silica ratio | Mass % | 88 | 88 | 88 | 88 | 88 |
| Oil ratio | Mass % | 29 | 29 | 29 | 29 | 29 |
| (TB × EB)/(E′ × 100) | | 10 | 10 | 10 | 10 | 14 |
| Groove depth of main | mm | 8 | 8 | 8 | 8 | 8 |
| groove | | | | | | |
| Main groove area ratio | % | 15 | 20 | 25 | 27 | 23 |
| Wear resistance | Index value | 104 | 104 | 103 | 103 | 104 |
| performance | | | | | | |
| Low rolling | Index value | 101 | 103 | 103 | 104 | 101 |
| performance | | | | | | |
| Wet performance | Index value | 3 | 3.5 | 3.5 | 3.5 | 3 |
| Durability | Index value | 5 | 5 | 5 | 4 | 5 |

Types of raw materials used as indicated in Tables 1 to 3 are described below.

NR: Natural rubber, SIR 20 (glass transition temperature: −65° C.)

SBR-1: Styrene butadiene rubber, TUFDENE E581 (glass transition temperature: −36° C.), available from Asahi Kasei Corporation

SBR-2: Styrene-butadiene rubber, NIPOL 1739 (glass transition temperature: −41° C.), available from ZEON CORPORATION

Br: Butadiene rubber, UBEPOL BR150 (glass transition temperature: −106° C.), available from Ube Industries, Ltd.

Silica 1: ZEOSIL 1165MP (CTAB specific surface area: 160 m²/g), available from SOLVAY

Silica 2: ZEOSIL Premium 200MP (CTAB specific surface area: 200 m²/g), available from SOLVAY

Silica 3: ZEOSIL 1115MP (CTAB specific surface area: 115 m²/g), available from SOLVAY

CB: carbon black, Niteron #300 IH, available from Nippon Steel Chemical Carbon Co. Ltd.

Silane coupling agent: Si 69, available from EVONIK

Aroma oil: Extract No. 4S, available from Showa Shell Sekiyu K.K.

Zinc oxide: Zinc Oxide III, available from Seido Chemical Industry Co., Ltd.

Sulfur: oil treated sulfur, available from Hosoi Chemical Industry Co., Ltd.

Vulcanization accelerator: NOCCELER CZ-G, available from Ouchi Shinko Chemical Industrial Co., Ltd.

As is clear from Tables 1 to 3, the pneumatic tires of Examples 1 to 15 had improved wear resistance performance, low rolling performance, and wet performance over the pneumatic tire of Standard Example 1 while maintaining durability. Further, these aspects of performance can be provided in a well-balanced manner.

On the other hand, in the pneumatic tire of Comparative Example 1, wet performance and durability were adversely affected because the rubber composition for the tread did not contain butadiene rubber. In the pneumatic tire of Comparative Example 2, wet performance and durability were adversely affected because the rubber composition for the tread did not contain natural rubber. In the pneumatic tire of Comparative Example 3, wear resistance performance, wet performance, and durability were adversely affected because the compounded amount of aroma oil in the rubber composition for the tread was too high. In the pneumatic tire of Comparative Example 4, wet performance was adversely affected because the compounded amount of silica was too low. In the pneumatic tire of Comparative Example 5, wear resistance was adversely affected because the compounded amount of silica was too high. In the pneumatic tire of Comparative Example 6, wet performance was adversely affected because the groove depth of the main grooves was too small. In the pneumatic tire of Comparative Example 7, wear resistance performance and durability were adversely affected because the groove depth of the main grooves was too large.

1. A pneumatic tire, comprising:
a tread portion having an annular shape and extending in a tire circumferential direction;
a pair of sidewall portions disposed on both sides of the tread portion; and
a main groove extending in the tire circumferential direction in a surface of the tread portion,
the main groove having a groove depth of from 7 mm to 11 mm,
a rubber composition for a tread comprising, as a rubber component, a natural rubber, a styrene-butadiene rubber, and a butadiene rubber, the rubber composition for a tread constituting the tread portion,
the rubber component having an average glass transition temperature Tg of −50° C. or lower,
silica being compounded in the rubber composition for a tread at 50 parts by mass to 100 parts by mass per 100 parts by mass of the rubber component,
a compounded amount of the silica being 80 mass % or more of a total amount of carbon black and the silica, and
aroma oil being compounded in the rubber composition for a tread at 40 mass % or less relative to an amount of the silica.

2. The pneumatic tire according to claim 1, wherein the silica has a CTAB specific surface area of from 140 m²/g to 220 m²/g.

3. The pneumatic tire according to claim 1, wherein an area ratio of the main groove to a ground contact area is from 20% to 25%.

4. The pneumatic tire according to claim 1, wherein a strength at break TB (MPa), an elongation at break EB (%), and a storage modulus E′ (MPa) of the rubber composition for a tread satisfy a relationship of 8≤(TB×EB)/(E′×100).

5. The pneumatic tire according to claim 2, wherein an area ratio of the main groove to a ground contact area is from 20% to 25%.

6. The pneumatic tire according to claim 5, wherein a strength at break TB (MPa), an elongation at break EB (%), and a storage modulus E′ (MPa) of the rubber composition for a tread satisfy a relationship of 8≤(TB×EB)/(E′×100).
